(19) United States
(12) Patent Application Publication
(10) Pub. No.: US 2022/0067304 A1
(43) Pub. Date: Mar. 3, 2022

(54) Energy-Based Language Models

(71) Applicant: Google LLC, Mountain View, CA (US)

(72) Inventors: Thang Minh Luong, Santa Clara, CA (US); Quoc V. Le, Sunnyvale, CA (US); Kevin Stefan Clark, San Francisco, CA (US)

(21) Appl. No.: 17/458,678

(22) Filed: Aug. 27, 2021

Related U.S. Application Data
(60) Provisional application No. 63/070,933, filed on Aug. 27, 2020.

(51) Int. Cl. G06F 40/40; G06F 40/284

(52) U.S. Cl. CPC G06F 40/40; G06F 40/284

(57) ABSTRACT

Systems and methods are provided for training and using energy-based language models such as cloze language models. In particular, one aspect of the present disclosure is directed to an energy-based cloze language model for representation learning over text. In some instances, the models provided herein can be referred to as the “Electric” model. Similar to the BERT model, example models proposed herein can be a conditional generative model of tokens given their contexts. However, example models proposed herein do not mask text or output a full distribution over tokens that could occur in a context. Instead, the example proposed models assign a scalar energy score to each input token. Another aspect of the present disclosure provides techniques to train the proposed models to assign low energies to data tokens and high energies to other ones using an algorithm based on noise-contrastive estimation.

### RELATED APPLICATIONS

This application claims priority to and the benefit of U.S. Provisional Patent Application No. 63/070,933. U.S. Provisional Patent Application No. 63/070,933 is hereby incorporated by reference in its entirety.

### FIELD

The present disclosure relates generally to natural language processing (NLP). More particularly, the present disclosure relates to systems and methods for training and using energy-based language models such as cloze language models.

### BACKGROUND

Early works on pre-training text encoders used language modeling objectives. A disadvantage of these methods is that the resulting model is unidirectional—the model does not see future tokens when producing a representation for the current one. Therefore current state-of-the-art pre-training methods primarily rely on masked language modeling (MLM). These approaches select a small subset of the input (typically around 15%), mask the token identities or attention to those tokens, and then train the model to recover the original input. While resulting in bidirectional models, these objectives incur a substantial compute cost. As one example, the significant compute cost can be attributed in part to the fact that the model only learns from 15% of the tokens per example. Furthermore, these existing methods have so far followed the standard recipe of estimating token probabilities with an output softmax and using maximum-likelihood training, with other kinds of generative models remaining unexplored.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to train a machine-learned language model. The method includes obtaining, by a computing system comprising one or more computing devices, an original language input that comprises a plurality of positive tokens. The method includes generating, by the computing system, one or more noise tokens. The method includes respectively replacing, by the computing system, one or more of the plurality of positive tokens in the original language input with the one or more noise tokens to form a noised language input that comprises a plurality of updated input tokens. The method includes processing, by the computing system, the noised language input with the machine-learned language model to produce a plurality of scores respectively for the plurality of updated input tokens, wherein the score for each updated input token indicates a likelihood of the updated input token given the other updated input tokens in the noised language input. The method includes generating, by the computing system, a plurality of predictions respectively for the plurality of updated input tokens based at least in part on the plurality of scores, wherein the prediction produced by the machine-learned language model for each updated input token predicts whether such updated input token is a positive token or a noise token. The method includes training, by the computing system, the machine-learned language model based at least in part on a loss function that evaluates the plurality of predictions.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts data flow in an example process to employ a machine-learned language model according to example embodiments of the present disclosure.

FIG. 1B depicts data flow in an example process to train a machine-learned language model according to example embodiments of the present disclosure.

FIG. 2A depicts a block diagram of an example computing system according to example embodiments of the present disclosure.

FIG. 2B depicts a block diagram of an example computing device according to example embodiments of the present disclosure.

FIG. 2C depicts a block diagram of an example computing device according to example embodiments of the present disclosure.

FIGS. 3A and 3B show example training algorithms according to example embodiments of the present disclosure.

Reference numerals that are repeated across plural figures are intended to identify the same features in various implementations.

### DETAILED DESCRIPTION

### Overview

Generally, the present disclosure is directed to systems and methods for training and using energy-based language models such as cloze language models. In particular, one aspect of the present disclosure is directed to an energy-based cloze language model for representation learning over text. In some instances, the models provided herein can be referred to as the “Electric” model. Similar to the BERT model, example models proposed herein can be a conditional generative model of tokens given their contexts. However, example models proposed herein do not mask text or output a full distribution over tokens that could occur in a context. Instead, the example proposed models assign a scalar energy score to each input token. The scalar energy score can indicate how likely a token is given the context. Another aspect of the present disclosure provides techniques to train the proposed models to assign low energies to some data tokens and high energies to other ones using an algorithm based on noise-contrastive estimation. The proposed systems and methods solve the pre-train/fine-tune discrepancy of MASK tokens in BERT and allow the candidate token and context to interact in the transformer layers instead of only in an output softmax. The proposed models perform well when transferred to downstream tasks and are particularly effective at producing likelihood scores for text: An example implementation of the proposed model re-ranks speech recognition n-best lists better than language models and much faster than masked language models.

More particularly, many recent language representation learning methods train a large neural network to predict the identity of a token conditioned on the context to its left (“left” language models) or both sides (“cloze” language models). Unless explicitly indicated otherwise, the use of the term “language model” herein is intended to be inclusive of both left language models and cloze language models. These existing methods have so far followed the standard recipe of estimating token probabilities with an output softmax and using maximum-likelihood training, with other kinds of generative models remaining unexplored.

In contrast, the present disclosure proposes to train an Energy-Based Model (EBM) which may in some example implementations be called “Electric” to perform cloze language modeling. EBMs learn an energy function that assigns low energy values to inputs in the data distribution and high energy values to other inputs. They are flexible because they do not have to compute normalized probabilities. For example, Electric does not use masking or an output softmax, instead producing an energy score for each input token where a low energy indicates the token is likely. The present disclosure also provides a training algorithm that efficiently approximates a loss based on noise-contrastive estimation (See, Gutmann and Hyvarinen, Noise-contrastive estimation: A new estimation principle for unnormalized statistical models. In AISTATS 2010).

In U.S. Provisional Patent Application No. 63/070,933, example experiments are described which evaluate Electric on example datasets including the GLUE and SQuAD datasets. In the example experiments, Electric substantially outperforms BERT (Devlin et al., BERT: Pre-training of deep bidirectional transformers for language understanding. In NAACL-HLT 2019). A key advantage of Electric is its ability to efficiently produce do-log-likelihood scores (Salazar et al., Masked language model scoring. In ACL 2020) for text: Electric is better at re-ranking the outputs of a speech recognition system than GPT-2 (Radford et al., Language models are unsupervised multitask learners. 2019) and is many times faster at re-ranking compared to BERT. The results provided in U.S. Provisional Patent Application No. 63/070,933 suggest that energy based models are a promising alternative to the standard generative models currently used for language representation learning.

The systems and methods of the present disclosure provide a number of technical effects and benefits. As one example technical effect and benefit, the systems and methods of the present disclosure enable more efficient training of a language model. In particular, the use of a (conditional) noise-contrastive estimation loss provides a way to efficiently train an unnormalized model and prevents the need to compute a complete distribution or partition function, which may be prohibitively computationally expensive. Furthermore, example training algorithms are provided which replace multiple positive input tokens with negative noise samples, enabling simultaneous learning over multiple samples. This enables the model to learn (e.g., converge) faster and over fewer training iterations. The use of fewer training iterations to train the model conserves computing resources such as processor usage, memory usage, network bandwidth, etc.

As another example technical effect and benefit, the proposed techniques result in improved model performance. For example, one advantage of the proposed models is their ability to efficiently produce do-log-likelihood scores, resulting in improved model performance (e.g., at a re-ranking task). This can correspond to improved natural language processing performance (e.g., improved speech recognition, query suggestion, etc.).

With reference now to the Figures, example embodiments of the present disclosure will be discussed in further detail.

### Example Models

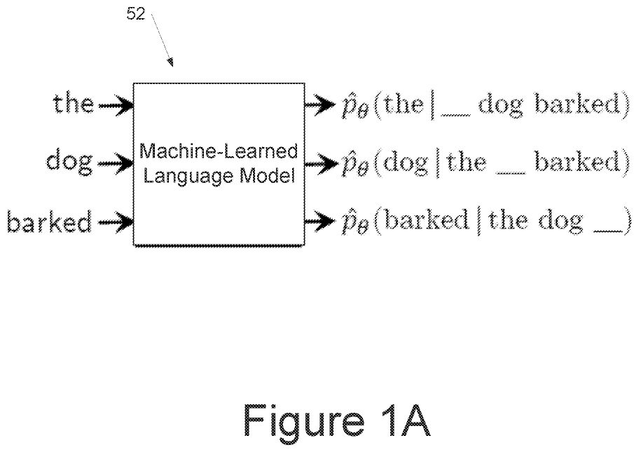

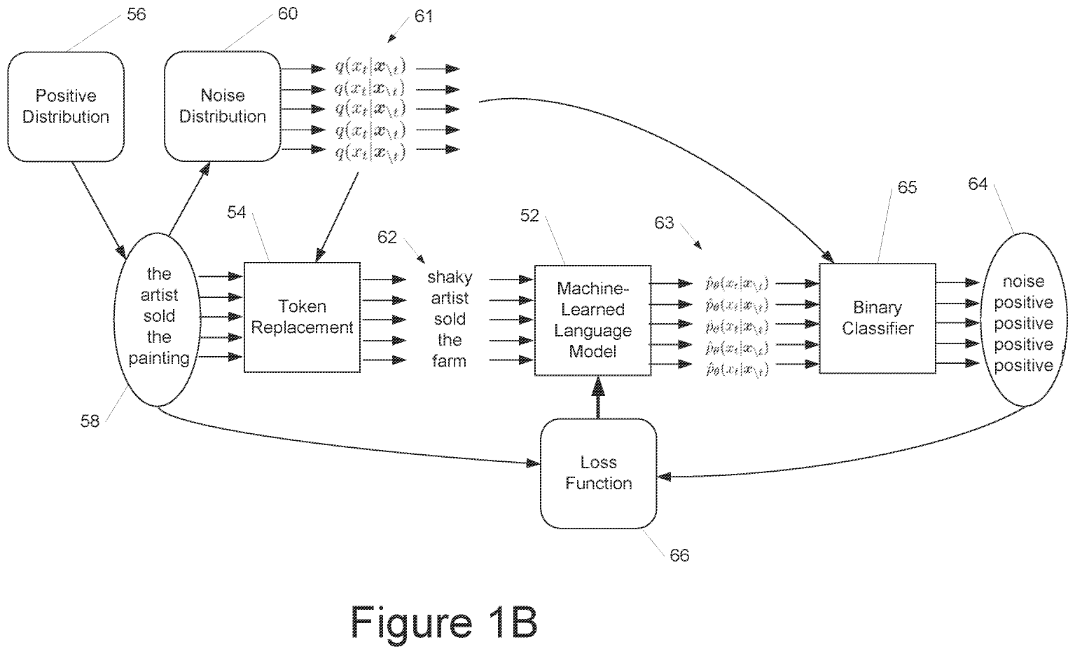

FIG. 1A depicts data flow in an example process to employ an example machine-learned language model 52 according to example embodiments of the present disclosure. The model 52 is provided as one example. The model 52 can model the probability of a token given a context. Specifically, in some implementations, the model 52 can produce un-normalized probabilities (but no full distribution) for all input tokens.

In particular, the model 52 can model p(xₜ|x_{\t}) of a token xₜ occurring in the surrounding context x_{\t}=[x₁, . . . xₜ₋₁, xₜ₊₁, . . . xₙ]. However, unlike BERT and many subsequent pre-training methods, the example model 52 does not use masking or a softmax layer. The model 52 can first map the unmasked input x=[x₁, . . . , xₙ]. into contextualized vector representations h(x)=[h₁, . . . , hₙ] using, for example, a transformer network. The model can assign a given position t an energy score

E(x)ₜ=w^{T}h(x)ₜ

using a learned weight vector w. The energy function can define a distribution over the possible tokens at position t as

$$p θ ( {x}_{t} \vert {x}_{\backslash t} ) = exp ( - {E ( x )}_{t} ) / Z ( {x}_{\backslash t} ) \\ = \frac{exp ( - E {( x )}_{t} )}{{\sum }_{{x}^{′} ∈ v} exp ( - E ( REPLACE ( x , t , {x}^{′} ) , t ) )}$$

where REPLACE(x, t, x′) denotes replacing the token at position t with x′ and V is the vocabulary, e.g., usually word pieces.

Unlike with BERT, which produces the probabilities for all possible tokens x′ using a softmax layer, a candidate x′ is passed in as input to the transformer. As a result, computing p_{θ} is prohibitively expensive because the partition function Z_{θ}(x_{\t}) requires running the transformer |V| times.

As computing the exact likelihood is typically intractable, training energy-based models such as Electric with standard maximum-likelihood estimation is typically not possible. Instead, example implementations of the present disclosure use (conditional) Noise-Contrastive Estimation (NCE) (Gutmann and Hyvarinen, 2010; Ma and Collins, 2018), which provides a way of efficiently training an unnormalized model that does not compute Z_{θ}(x_{\t}).

NCE learns the parameters of a model by defining a binary classification task where samples from the data distribution have to be distinguished from samples generated by a noise distribution q(xₜ|x_{\t}). First, the un-normalized output can be defined as

\hat{p}_{θ}(xₜ|x_{\t})=exp(−E(x)ₜ)

Operationally, NCE can be viewed as follows:

A positive data point can be a text sequence x from the data and position in the sequence t.

A negative data point can be the same except xₜ, the token at position t, is replaced with a noise token \hat{x}ₜ sampled from the noise distribution q.

A binary classifier can be defined that estimates the probability of a data point being positive as:

$${D ( x )}_{t} = \frac{n \cdot \hat{p} θ ( {x}_{t} \vert {x}_{\backslash t} )}{n \cdot \hat{p} θ ( {x}_{t} \vert {x}_{\backslash t} ) + k \cdot q ( {x}_{t} \vert {x}_{\backslash t} )}$$

The binary classifier can be trained to distinguish positive vs negative data points, with k negatives sampled for every n positive data points.

Formally, one example NCE loss £(θ) is

$$n \cdot {𝔼}_{x , t} [ - log \frac{n \cdot \hat{p} θ ( {x}_{t} \vert {x}_{\backslash t} )}{n \cdot \hat{p} θ ( {x}_{t} \vert {x}_{\backslash t} ) + k \cdot q ( {x}_{t} \vert {x}_{\backslash t} )} ] + k \cdot {𝔼}_{{x , t}_{{\hat{x}}_{t} \sim q}} [ - log \frac{k \cdot q ( {\hat{x}}_{t} \vert {x}_{\backslash t} )}{n \cdot \hat{p} θ ( {\hat{x}}_{t} \vert {x}_{\backslash t} ) + k \cdot q ( {\hat{x}}_{t} \vert {x}_{\backslash t} )} ]$$

This loss is minimized when \hat{p}_{θ}=p_{data}. A consequence of this property is that the model is trained to be self-normalized such that Z_{θ}(x_{\t})=1.

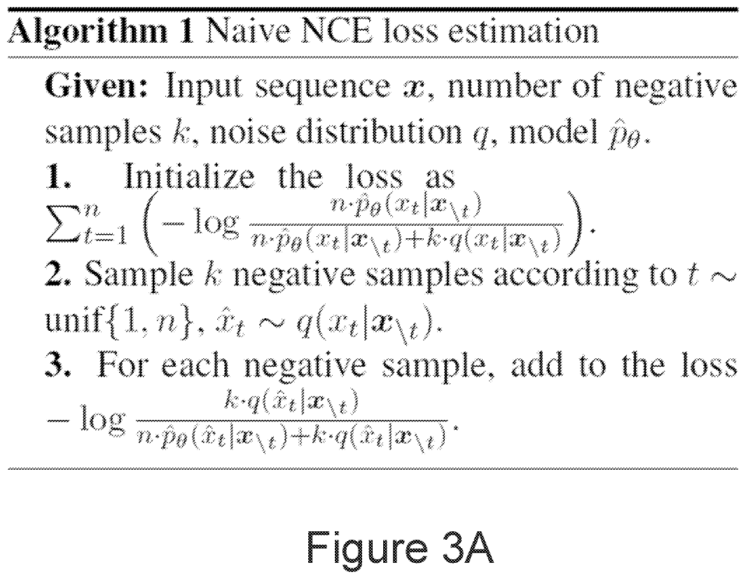

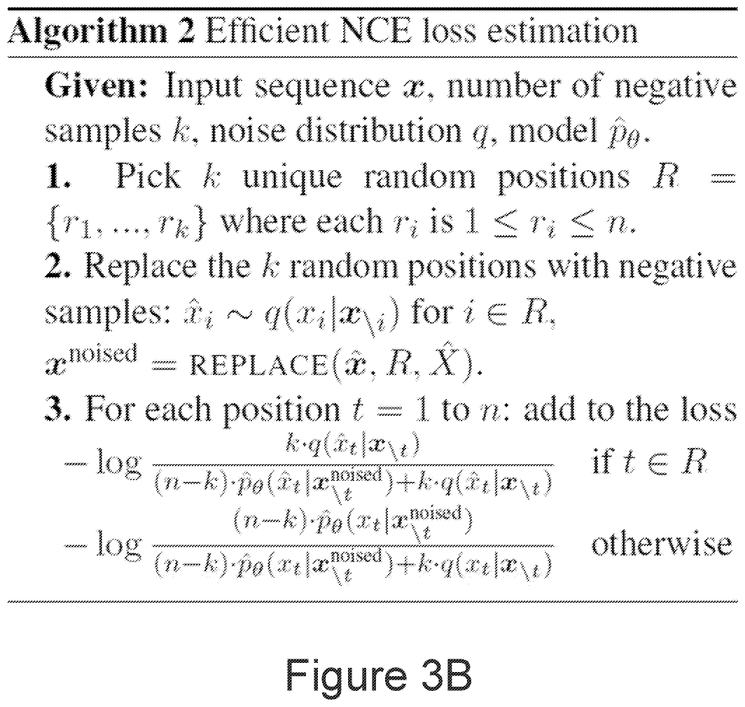

To minimize the loss, the expectations could be approximated by sampling as shown in Algorithm 1, shown in FIG. 3A and also reproduced below. Taking the gradient of this estimated loss produces an unbiased estimate of ∇_{θ}£(θ).

Algorithm 1 Naive NCE loss estimation

Given: Input sequence x, number of negative
samples k, noise distribution q, model \hat{p}_{θ}.
1. Initialize the loss as
${Σ}_{t = 1}^{n} ( - log \frac{n \cdot {\hat{p}}_{θ} ( {x}_{t} \vert {x}_{\backslash t} )}{n \cdot {\hat{p}}_{θ} ( {x}_{t} \vert {x}_{\backslash t} ) + k \cdot q ( {x}_{t} \vert {x}_{\backslash t} )} ) .$
2. Sample k negative samples according to t ~
unif{1, n}, \hat{x}ₜ ~ q(xₜ|x_{\t}).
3. For each negative sample, add to the loss
$- log \frac{k \cdot q ( {\hat{x}}_{t} \vert {x}_{\backslash t} )}{n \cdot {\hat{p}}_{θ} ( {\hat{x}}_{t} \vert {x}_{\backslash t} ) + k \cdot q ( {\hat{x}}_{t} \vert {x}_{\backslash t} )}$ .

However, in practice, this algorithm is computationally expensive, since it requires k+1 forward passes through the transformer to compute the \hat{p}_{θ}s (once for the positive samples and once for each negative sample).

Thus, another aspect of the present disclosure proposes a much more efficient approach that replaces k input tokens with noise samples simultaneously. One example implementation of this approach is shown in Algorithm 2, which is shown in FIG. 3B and also reproduced below.

Algorithm 2 Efficient NCE loss estimation

Given: Input sequence x, number of negative
samples k, noise distribution q, model \hat{p}_{θ}.
1. Pick k unique random positions R =
{r₁, . . . , rₖ} where each rᵢ is 1 ≤ rᵢ ≤ n.
2. Replace the k random positions with negative
samples: \hat{x}ᵢ ~ q(xᵢ|x_{\i}) for i ∈ R,
x^{noised} = REPLACE (\hat{x}, R, \hat{X}).
3. For each position t = 1 to n: add to the loss
$- log \frac{k \cdot q ( {\hat{x}}_{t} \vert {x}_{\backslash t} )}{( n - k ) \cdot {\hat{p}}_{θ} ( {\hat{x}}_{t} \vert {x}_{\backslash t}^{noised} ) + k \cdot q ( {\hat{x}}_{t} \vert {x}_{\backslash t} )} if t ∈ R$
$- log \frac{( n - k ) \cdot {\hat{p}}_{θ} ( {x}_{t} \vert {x}_{\backslash t}^{noised} )}{( n - k ) \cdot {\hat{p}}_{θ} ( {x}_{t} \vert {x}_{\backslash t}^{noised} ) + k \cdot q ( {x}_{t} \vert {x}_{\backslash t} )} otherwise$

This approach requires just one pass through the transformer fork noise samples and n−k data samples. However, note that this procedure only truly minimizes [symbol] if

\hat{p}_{θ}(xₜ|x_{\t})=\hat{p}_{θ}(xₜ|x_{\t}^{noised})

To apply this efficiency trick the assumption can be made that they are approximately equal, which is reasonable because (1) one can choose a small k (e.g., 0.15n) and (2) q can be trained to be close to the data distribution (see below).

Some example noise distributions q can come from a neural network trained to match p_{data}. In particular, one example approach is to use a two-tower cloze language model as proposed by Baevski et al. Cloze-driven pretraining of self-attention networks. arXiv preprint arXiv:1903.07785 (2019), which is more accurate than a left language model because it uses context to both sides of each token. The model can run two transformers T_{LTR} and T_{RTL} over the input sequence, one with attention masking so it processes the sequence left-to-right and the other operating right-to-left. The model's prediction can come from a softmax layer applied to the concatenated states of the two transformers:

[symbol]

=T_{LTR}(x), [symbol] T_{RTL}(x)

q(xₜ|x_{\t})=softmax(W([ [symbol] ₜ₋₁, [symbol] ₜ₊₁])ₓ_{ₜ}

In some implementations, the noise distribution can be trained simultaneously with the language model using, for example, standard maximum likelihood estimation over the data.

An example summary of one example implementation of Electric is:

| Model | Noise Dist. | Binary Classifier |
|---|---|---|
| Electric | Two-Tower Cloze LM | $\frac{exp ( - s )}{exp ( - \text{?} ) + \text{?} ( x \vert {x}_{\backslash t} )}$ |

$\text{?} \text{indicates text missing or illegible when filed}$

where

s=w^{T}h(x)ₜ

is a score produced by the transformer.

As one example training process, FIG. 1B depicts data flow in an example process to train a machine-learned language model 52 according to example embodiments of the present disclosure.

The process can include obtaining an original language input 58 that comprises a plurality of positive tokens (e.g., [the, artist, sold, the, painting]). The positive tokens can be arranged in a pre-defined sequence. For example, the original language input 58 can be obtained from a positive distribution 56.

The training process can include selecting one or more the plurality of positive tokens to serve as one or more replaced tokens. The training process can include generating one or more noise tokens. For example, the noise tokens can be sampled from or otherwise generated based on a noise distribution 60. For example, the noise distribution 60 can generate proposed replacement tokens 61 given the context from the original language input 58. In one example, the noise distribution 60 can be a learned model such as, for example, a two-tower cloze model. In one example, the proposed replacement tokens 61 can be the candidate tokens in a noise vocabulary that receive a largest score q(xₜ|x_{\t}) from the noise distribution 60 given the surrounding context tokens.

As shown at 54, the process can include respectively replacing the one or more replaced tokens in the original language input 58 with the one or more replacement noise tokens 61 to form a noised language input 62 that comprises a plurality of updated input tokens that are a mixture of the replacement noise tokens 61 and some of the positive tokens of the original language input 58. Specifically, the plurality of updated input tokens can include the one or more inserted replacement noise tokens and the plurality of positive tokens that were not selected to serve as replaced tokens. For example, the noised language input includes [shaky, artist, sold, the, farm], where ‘shaky’ and ‘farm’ are inserted replacement noise tokens generated from the noise distribution 60 and ‘artist’, ‘sold’, and ‘the’ are positive tokens remaining from the original input 58.

The training process can include processing the noised language input 62 with the machine-learned language model 52 to produce a plurality of energy scores 63 respectively for the plurality of updated input tokens in the noised input 62. For example, the energy score 63 \hat{p}_{θ}(xₜ|x_{\t}) for each token in the noised language input 62 can indicate a likelihood of the token given the surrounding context tokens and the positive distribution 56.

A binary classifier 65 can receive the scores 61 from the noise distribution and the scores 63 from the machine-learned language model 52 and can generate a plurality of predictions 64 for the updated input tokens 62. For example, the prediction 64 produced by the binary classifier 65 for each updated input token 62 can predict whether such updated input token is a positive token or a noise token. For example, for the token ‘shaky’, the classifier 65 has correctly predicted that such token is noise. Likewise, for the token ‘artist’, classifier 65 has correctly predicted that such token is positive. However, for the token ‘farm’, the classifier 65 has incorrectly predicted that such token is positive, when in fact it is noise.

The training process can include training the machine-learned language model 52 based at least in part on a loss function 66 that evaluates the plurality of predictions 64 produced by the binary classifier 65. For example, a loss function 66 can be used to update values of weights or other parameters of the model 52 (e.g., using a gradient-based optimization technique). In some implementations, the noise distribution 60 and/or the binary classifier 65 can be updated or trained based on loss functions as well. For example, the noise distribution 60 can be trained using a second loss function that evaluates presence of the noise tokens within a noise distribution (e.g., a maximum likelihood estimation function). The process shown in FIG. 1B can be performed iteratively.

In some implementations, following the training process illustrated in FIG. 1B, the machine-learned language model 52 can be fine-tuned to perform a language processing task. As examples, language processing tasks can include question answering; next word or sentence completion or prediction; translation; entity recognition; language classification; natural language understanding; output re-ranking; and other language tasks.

One example advantage of the proposed models over BERT is that it can efficiently produce pseudo-loglikelihood (PLL) scores for text. Example PLLs for Electric are

$$PLL ( x ) = {\sum }_{t = 1}^{n} log ( \hat{p} θ ( {x}_{t} \vert {x}_{\backslash t} ) ) = {\sum }_{t = 1}^{n} - {E ( x )}_{t}$$

and can be used to re-rank the outputs of, e.g., an NMT or ASR system, a query suggestion system, a chat bot, and/or other systems where it is beneficial for generated language outputs to appear natural or mimic human language characteristics.

While historically log-likelihoods from language models have been used for such reranking, recent work has demonstrated that PLLs from masked language models perform better. However, computing PLLs from a masked language model requires n passes of the transformer: once with each word masked out. Salazar et al. (2020) suggest distilling BERT into a model that uses no masking to avoid this cost, but this model considerably underperformed regular language models in their experiments. In contrast, example proposed models can produce estimated probabilities for all input tokens in a single pass.

### Example Devices and Systems

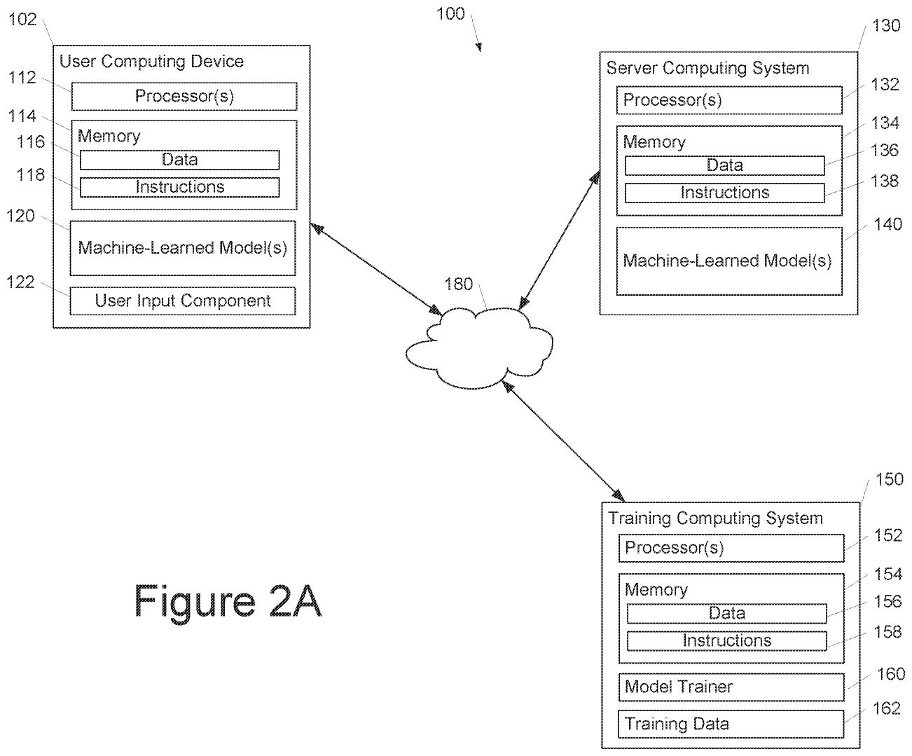

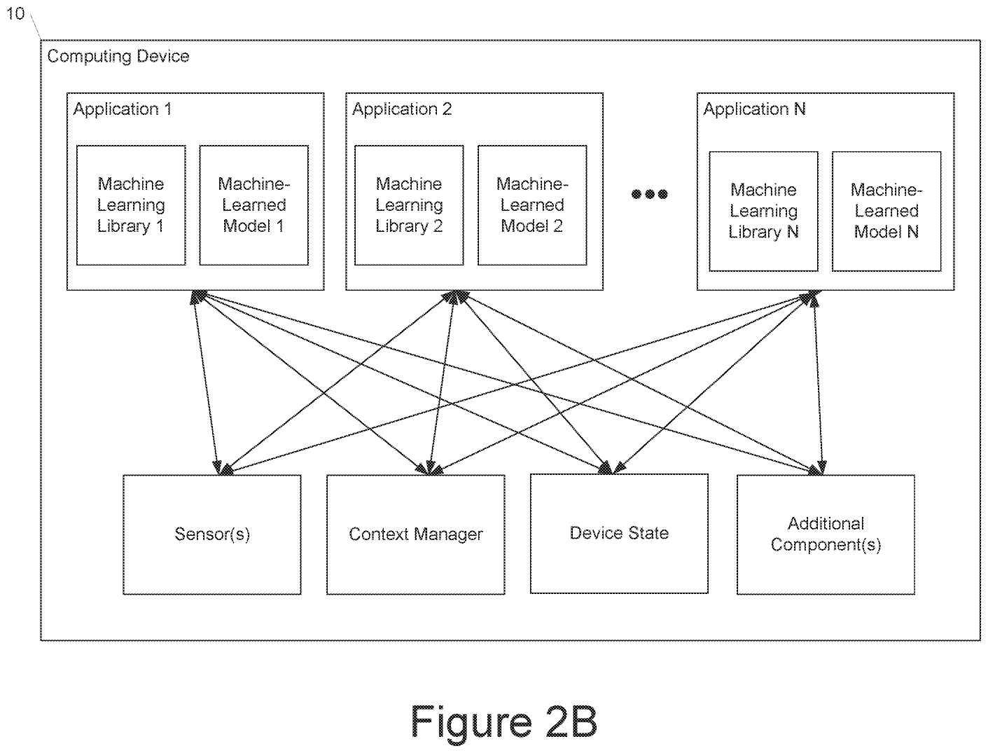

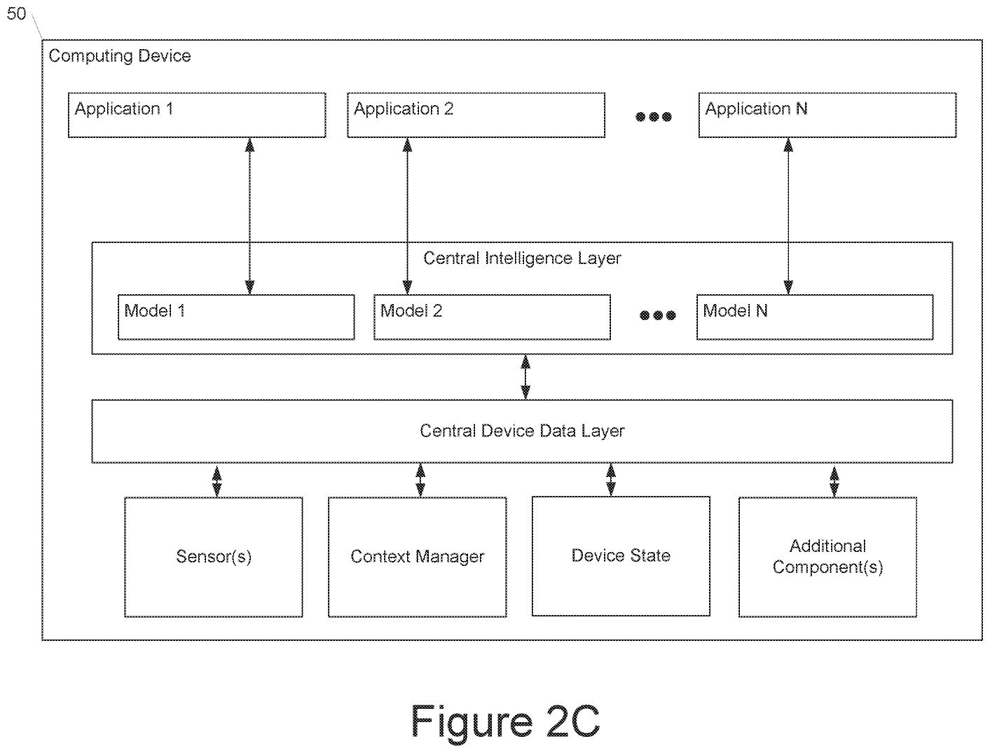

FIG. 2A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 120 are discussed with reference to FIG. 1.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel language encoding/processing across multiple instances of language tokens).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a language processing service service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 1.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, sets of example input tokens.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 2A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 2B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations of the described techniques may include hardware, a method or process, or computer software on a computer-accessible medium.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to train a machine-learned language model, the method comprising:
for each of one or more training iterations:
obtaining, by a computing system comprising one or more computing devices, an original language input that comprises a plurality of positive tokens;
generating, by the computing system, one or more noise tokens;
respectively replacing, by the computing system, one or more of the plurality of positive tokens in the original language input with the one or more noise tokens to form a noised language input that comprises a plurality of updated input tokens;
processing, by the computing system, the noised language input with the machine-learned language model to produce a plurality of scores respectively for the plurality of updated input tokens, wherein the score for each updated input token indicates a likelihood of the updated input token given the other updated input tokens in the noised language input;
generating, by the computing system, a plurality of predictions respectively for the plurality of updated input tokens based at least in part on the plurality of scores, wherein the prediction produced by the machine-learned language model for each updated input token predicts whether such updated input token is a positive token or a noise token; and
training, by the computing system, the machine-learned language model based at least in part on a loss function that evaluates the plurality of predictions.

2. The computer-implemented method of claim 1, wherein:
the machine-learned language model comprises an energy-based cloze language model; and
the plurality of scores respectively for the plurality of updated input tokens comprise a plurality of scalar energy scores respectively for the plurality of updated input tokens.

3. The computer-implemented method of claim 1, wherein generating, by the computing system, the one or more noise tokens comprises generating, by the computing system, the one or more noise tokens using a machine-learned language generator model.

4. The computer-implemented method of claim 3, wherein the machine-learned language generator model comprises a two-tower cloze language model that comprises two transformer models.

5. The computer-implemented method of claim 3, further comprising:
training, by the computing system, the machine-learned language generator model based at least in part on a second loss function that evaluates presence of the noise tokens within a noise distribution.

6. The computer-implemented method of claim 5, wherein the second loss function comprises a maximum likelihood estimation function.

7. The computer-implemented method of claim 1, wherein generating, by the computing system, the one or more noise tokens comprises sampling, by the computing system, the one or more noise tokens from a noise distribution.

8. The computer-implemented method of claim 1, wherein obtaining, by the computing system, the original language input that comprises the plurality of positive tokens comprises sampling, by the computing system, the plurality of positive tokens from a positive distribution.

9. The computer-implemented method of claim 1, wherein the loss function comprises a conditional noise-contrastive estimation loss function.

10. The computer-implemented method of claim 1, wherein the machine-learned language model comprises a transformer network text encoder.

11. The computer-implemented method of claim 1, wherein, when one of the noise tokens is equal to the original token it replaces, the loss function evaluates such noise token as if it was included in the original input tokens.

12. The computer-implemented method of claim 1, wherein:
obtaining, by the computing system, the original language input that comprises the plurality of positive tokens comprises obtaining, by the computing system, a pre-defined sequence of positive tokens from a positive distribution;
generating, by the computing system, the one or more noise tokens comprises generating, by the computing system, a plurality of noise tokens; and
respectively replacing, by the computing system, the one or more in the original language input with the one or more noise tokens comprises respectively replacing, by the computing system, a plurality of tokens in the pre-defined sequence of positive tokens with the plurality of noise tokens.

13. The computer-implemented method of claim 1, wherein:
the one or more training iterations comprise one or more pre-training iterations; and
the method further comprises, after the one or more pre-training iterations:
performing one or more fine-tuning training iterations in which the machine-learned language model is trained to perform a language task.

14. The computer-implemented method of claim 1, wherein the plurality of original input tokens comprise a plurality of original words.

15. A computing system, comprising:
one or more processors; and
one or more non-transitory computer-readable media that store instructions that when executed cause the computing system to perform operations, the operations comprising:
for each of one or more training iterations:
obtaining, by the computing system, an original language input that comprises a plurality of positive tokens;
generating, by the computing system, one or more noise tokens;
respectively replacing, by the computing system, one or more of the plurality of positive tokens in the original language input with the one or more noise tokens to form a noised language input that comprises a plurality of updated input tokens;
processing, by the computing system, the noised language input with the machine-learned language model to produce a plurality of scores respectively for the plurality of updated input tokens, wherein the score for each updated input token indicates a likelihood of the updated input token given the other updated input tokens in the noised language input;
generating, by the computing system, a plurality of predictions respectively for the plurality of updated input tokens based at least in part on the plurality of scores, wherein the prediction produced by the machine-learned language model for each updated input token predicts whether such updated input token is a positive token or a noise token; and
training, by the computing system, the machine-learned language model based at least in part on a loss function that evaluates the plurality of predictions.

16. The computing system of claim 15, wherein the one or more non-transitory computer-readable media further store the machine-learned language model.

17. The computing system of claim 15 or 16, wherein the one or more non-transitory computer-readable media further store the machine-learned language generator model.

18. One or more non-transitory computer-readable media that store a machine-learned language model produced through performance of operations, the operations comprising:
for each of one or more training iterations:
obtaining, by a computing system, an original language input that comprises a plurality of positive tokens;
generating, by the computing system, one or more noise tokens;
respectively replacing, by the computing system, one or more of the plurality of positive tokens in the original language input with the one or more noise tokens to form a noised language input that comprises a plurality of updated input tokens;
processing, by the computing system, the noised language input with the machine-learned language model to produce a plurality of scores respectively for the plurality of updated input tokens, wherein the score for each updated input token indicates a likelihood of the updated input token given the other updated input tokens in the noised language input;
generating, by the computing system, a plurality of predictions respectively for the plurality of updated input tokens based at least in part on the plurality of scores, wherein the prediction produced by the machine-learned language model for each updated input token predicts whether such updated input token is a positive token or a noise token; and
training, by the computing system, the machine-learned language model based at least in part on a loss function that evaluates the plurality of predictions.

19. The one or more non-transitory computer-readable media of claim 18, wherein:
the machine-learned language model comprises an energy-based cloze language model; and
the plurality of scores respectively for the plurality of updated input tokens comprise a plurality of scalar energy scores respectively for the plurality of updated input tokens.

20. The one or more non-transitory computer-readable media of claim 18, wherein generating, by the computing system, the one or more noise tokens comprises generating, by the computing system, the one or more noise tokens using a machine-learned language generator model.
